(19) United States
(12) Patent Application Publication
(10) Pub. No.: US 2018/0104973 A1
(43) Pub. Date: Apr. 19, 2018

(54) PRESSURE IMAGING AND INDICATING MATERIALS AND DEVICES

(71) Applicants: Bryan Greener, York (GB); ACTIVE DEVICE DEVELOPMENT LTD, York (GB)

(72) Inventor: Bryan Greener, York (GB)

(21) Appl. No.: 15/562,846

(22) PCT Filed: Mar. 30, 2016
(86) PCT No.: PCT/GB2016/050881

§ 371 Date: Sep. 28, 2017

(30) Foreign Application Priority Data
Apr. 7, 2015 (GB) 1505874.6

(51) Int. Cl. B41M 5/136

(52) U.S. Cl. CPC B41M 5/136

(57) ABSTRACT

This invention relates to pressure indicating materials, in particular sheet materials that indicate pressure by a colour transformation. Materials and two-sheet pressure imaging means are described that comprise a first sheet material comprising a microporous membrane within which is associated a solution comprising a colour former and a second sheet comprising a colour developer.

### FIELD OF THE INVENTION

This invention relates to pressure indicating materials, in particular sheet materials that indicate pressure by a colour transformation.

### BACKGROUND TO THE INVENTION

Fuji Photo Film Co., Ltd (herein “Fuji”) produces a range of such pressure imaging materials, marketed under the name Prescale. These materials are available in a range of pressure imaging windows, spanning the range 0.2-130 MPa (Mega Pascals) and are further described in prior art GB1337140, GB1338784, GB1356128, GB1372267, GB1429069 and GB1445113 for example. The principle of operation of these materials relies upon two components: microspheres containing a solution of a colour-forming dye, commonly known as a colour former, and a colour developer (these terms will be defined further herein).

The microspheres containing colour former, and the colour developer may be present as an intimate mixture upon the same sheet surface or may be present on two separate sheet surfaces that are brought into association at the time of use. When sufficient pressure is applied to the assembly, the microspheres become ruptured and release the colour former solution, which can then interact directly with the colour developer. When the colour former solution contacts the colour developer, a strong and irreversible colour change is the result. FIG. 1 depicts an extract from the Fuji Prescale Film Instruction Manual.

U.S. Pat. No. 3,940,275 and prior art referenced therein describe earlier developments in this field, assigned to The National Cash Register Company of Dayton, Ohio; for example, see U.S. Pat. No. 2,712,507, U.S. Pat. No. 2,800,457 and U.S. Pat. No. 3,041,289.

Fuji's pressure imaging film is a commercial success but it has some limitations. For example, the pressure threshold above which colour is developed is determined by the microsphere size: the larger the microsphere, the more easily it is ruptured by pressure. This means that the lowest pressure threshold material comprises the largest microspheres; the larger the microspheres, the poorer the resulting image resolution. Furthermore, this limitation creates an undesirable limitation in the operating range of these materials; it would be desirable for at least some applications to have an activation pressure threshold below 0.2 MPa.

It is an aim of certain embodiments of the present invention to at least partially mitigate the problems associated with the prior art.

It is an aim of certain embodiments of the present invention to provide a material and/or a system which is capable of indicating application of pressure of less than about 0.3 MPa.

### SUMMARY OF INVENTION

In a broad aspect, the present invention is concerned with pressure imaging and indicating materials comprising two sheet materials. One material comprises a colour former solution and the other a colour developer. In contrast to the prior art, the colour former solution is contained within a microporous membrane. When the two sheet materials are correctly associated, the application of a suitable pressure forces at least a portion of the colour former solution from the microporous membrane and into contact with the colour developer, thus generating a strong colour.

The pressure response of the system accordingly to certain embodiments can be controlled by appropriate selection of: microporous membrane pore size, colour former solution viscosity and the loading weight of colour former solution within the microporous membrane. In general, reducing the membrane pore size, increasing the viscosity of the colour former solution and reducing the loading weight of the colour former solution within the microporous membrane all act to increase the pressure threshold at which a coloured image is first formed.

Accordingly, the first aspect of this invention is a sheet material comprising a microporous membrane within which is associated a solution comprising a colour former.

Herein “sheet material” is taken to mean any material of major x and y dimension and minor z dimension. Aptly, x and y vary independently within the range 1 mm to 500 m and z is within the range 1-1000 micrometres.

Herein “microporous membrane” is taken to mean any sheet material with an open volume within the range 10-90% and an average pore size within the range 0.1-5.0 micrometres.

Herein, “open volume”, also known as “free volume”, is taken to mean the internal volume of a microporous membrane that is not occupied by the material from which the membrane is constructed. For the avoidance of doubt, this is the percentage of space available to be occupied by a fluid such as air or such as a solution of a colour former or both.

Herein, “colour former” is taken to mean an electron-donative or proton-acceptive molecule or compound that exhibits a colour change when associated with an electron-acceptive or proton-donative molecule or compound that is a solid substance.

Furthermore, herein “colour former” is also taken to mean any of the classes of molecules or compounds defined as such and identified in the prior art documents: IE34334, IE34604, IE36466, IE36769, IE36852, GB1337140, GB1338784, GB1356128, GB1372267, GB1429069 and GB1445113.

Furthermore, herein “colour former” is taken to mean any leuco dye that is applied in thermochromic compositions or carbonless copy paper.

Herein, “leuco dye” is taken to mean a molecule that can exist in two coloured forms, one of which is typically colourless.

A second aspect of this invention is a pressure recording means comprising two sheet materials, wherein a first sheet material comprises a microporous membrane within which is associated a solution of a colour former and a second sheet material comprises a colour developer. Aptly, the pressure recording means is a pressure recording element or device or apparatus.

Herein, “colour developer” is taken to mean an electron-acceptive or proton-donative molecule or compound that is a solid substance.

Furthermore, herein “colour developer” is also taken to mean any of the classes of molecules or compounds defined as such in the prior art documents: GB1337140, GB1338784, GB1356128, GB1372267, GB1429069 and GB1445113.

A further aspect of this invention is a process for the impregnation of a microporous membrane with a solution of colour former that comprises:
a) diluting the colour former solution in a volatile solvent;
b) impregnating the microporous membrane with the resulting solution; and
c) removing the volatile solvent.

### BRIEF DESCRIPTION OF THE FIGURES

Certain embodiments of the present invention are described, by way of example only, in more detail below with reference to the accompanying Figures in which:

FIG. 1 shows an extract from the user instructions for two sheet FujiFilm Prescale pressure imaging films, depicting a first polyester base film (1) coated with a layer of micro-encapsulated colour former liquid (2), together comprising ‘A-Film’ (5), and a second polyester base film (4) coated with a colour developing layer (3), together comprising ‘C-Film’ (6). When the films are opposed and pressure is applied, the microcapsules are broken (7) and the colour forming liquid reacts with the colour developing material, resulting in red patches on the C-Film (8). When pressure is applied, the microcapsules are broken and the colour-forming material reacts with the colour-developing material. Red patches appears on the film. FIG. 1 represents prior art.

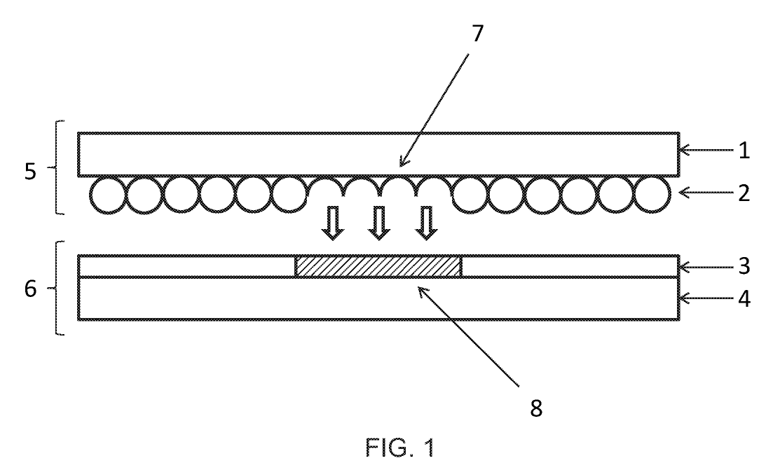

FIG. 2 shows the structures of phthalide-based colour formers (10), fluoran-based colour formers (20), sulfophthalide-based colour formers (30) and sulfofluoran-based colour formers (40).

FIG. 3 shows the structures of benzene-based molecules (50) and biphenyl-based molecules (60).

FIG. 4 is a greyscale false-colour image of the imprint of a 15 mm diameter polished stainless steel die, applied to a pressure imaging sheet combination according to Example 17. The number notation corresponds to kg force and is equivalent to the following applied pressures: 5=2.8 kg/cm², 10=5.7 kg/cm², 15=8.5 kg/cm², 20=11.3 kg/cm², 25=14.1 kg/cm², 30=17.0 kg/cm², 35=19.8 kg/cm², 40=22.6 kg/cm² and 45=25.5 kg/cm².

FIG. 5 is a greyscale false-colour image of the imprint of a 15 mm diameter polished stainless steel die, applied to a pressure imaging sheet combination according to Example 18. The number notation corresponds to kg force and is equivalent to the following applied pressures: 0.7=0.4 kg/cm², 0.1=0.06 kg/cm², 0.4=0.23 kg/cm², 1=0.57 kg/cm², 2=1.13 kg/cm², 3=1.70 kg/cm², 4=2.26 kg/cm², 5=2.83 kg/cm², 6=3.40 kg/cm², 7=3.96 kg/cm², 8=4.53 kg/cm², 9=5.09 kg/cm², 10=5.7 kg/cm², 15=8.5 kg/cm², 20=11.3 kg/cm², 25=14.1 kg/cm², 30=17.0 kg/cm² and 35=19.8 kg/cm².

FIG. 6 is a greyscale false-colour image of the imprint of a 15 mm diameter polished stainless steel die, applied to a pressure imaging sheet combination according to Example 19. The number notation corresponds to kg force and is equivalent to the following applied pressures: 0.5=0.28 kg/cm², 1=0.57 kg/cm², 2=1.13 kg/cm², 3=1.70 kg/cm², 4=2.26 kg/cm², 5=2.83 kg/cm², 6=3.40 kg/cm², 7=3.96 kg/cm², 8=4.53 kg/cm², 9=5.09 kg/cm², 10=5.7 kg/cm², 11=6.2 kg/cm², 15=8.5 kg/cm², 20=11.3 kg/cm², 25=14.1 kg/cm², 30=17.0 kg/cm², 35=19.8 kg/cm² and 40=22.6 kg/cm².

FIG. 7 is a greyscale false-colour image of the imprint of a 15 mm diameter polished stainless steel die, applied to a pressure imaging sheet combination according to Example 20. The number notation corresponds to kg force and is equivalent to the following applied pressures: Example 1, 1=0.57 kg/cm², 2=1.13 kg/cm², 3=1.70 kg/cm², 4=2.26 kg/cm² and 5=2.83 kg/cm²; Example 6-8, 10=5.7 kg/cm², 20=11.3 kg/cm², 30=17.0 kg/cm², 40=22.6 kg/cm² and 50=28.3 kg/cm².

FIG. 8 is a greyscale false-colour image of the imprint of a British £1 coin applied to a pressure imaging sheet combination according to Example 21.

FIG. 9 is a greyscale false-colour image of the imprint of a 15 mm diameter polished stainless steel die, applied to a pressure imaging sheet combination according to Example 22. The number notation corresponds to kg force and is equivalent to the following applied pressures: Example 9, 5=2.83 kg/cm², 10=5.7 kg/cm², 15=8.5 kg/cm², 20=11.3 kg/cm² and 30=17.0 kg/cm² and 40=22.6 kg/cm²; Example 10, 5=2.83 kg/cm², 10=5.7 kg/cm², 15=8.5 kg/cm², 20=11.3 kg/cm² and 30=17.0 kg/cm²; Example 11, 1=0.57 kg/cm², 3=1.70 kg/cm², 5=2.83 kg/cm², and 10=5.7 kg/cm².

FIG. 10 is a greyscale false-colour image of the imprint of a 20 mm diameter polished stainless steel die, applied to a pressure imaging sheet combination according to Example 41. The number notation corresponds to kg force and is equivalent to the following applied pressures (left to right): 1=0.32 kg/cm², 3=0.95 kg/cm², 5=1.59 kg/cm², 10=3.18 kg/cm², 15=4.77 kg/cm², 20=6.37 kg/cm², 30=9.55 kg/cm², 40=12.73 kg/cm² and 50=15.91 kg/cm².

FIG. 11 is a greyscale false-colour image of the imprint of a series of 20 mm diameter lenticular lens, varying in line density, applied to a pressure imaging sheet combination according to Example 42. A force of 15 kg was applied to each test. The number notation corresponds to the line density of each test article in lines per inch (left to right): 20, 30, 40, 60 lines per inch.

FIG. 12 is a greyscale false-colour image of the imprint of a British £1 coin against a flat silicone slab, applied to a pressure imaging sheet combination according to Example 43 (left) and Fuji Prescale LLLW (right). A force of 15 kg was applied to each test.

FIG. 13 is a greyscale false-colour image of the imprint of a 10 mm (left) and 6 mm (right) diameter polished stainless steel die, applied to a pressure imaging sheet combination according to Example 46. The number notation corresponds to kg force and is equivalent to the following applied pressures (left to right): 10 mm die: 10=12.7 kg/cm², 20=25.4 kg/cm², 30=38.2 kg/cm², 40=50.9 kg/cm² and 50=63.6 kg/cm²; 6 mm die: 10=35.3 kg/cm², 20=70.7 kg/cm², 30=106.0 kg/cm², 40=141.3 kg/cm² and 50=176.7 kg/cm².

FIG. 14 is a greyscale false-colour image of the imprint of a 10 mm diameter polished stainless steel die, applied to a pressure imaging sheet combination according to Example 49. The number notation corresponds to kg force and is equivalent to the following applied pressures (left to right): 10=12.7 kg/cm², 20=25.4 kg/cm², 30=38.2 kg/cm², 40=50.9 kg/cm² and 50=63.6 kg/cm².

### DETAILED DESCRIPTION OF CERTAIN EMBODIMENTS OF THE INVENTION

The first aspect of this invention is a sheet material comprising a microporous membrane within which is associated a solution comprising a colour former.

Herein “sheet material” is taken to mean any material of major x and y dimension and minor z dimension. Aptly, x and y vary independently within the range 1 mm to 500 m and z is within the range 1-1000 micrometres.

Herein “microporous membrane” is taken to mean any sheet material with an open volume within the range 10-90% and an average pore size within the range 0.1-5.0 micrometres. In certain embodiments, the microporous membrane may have an open volume of about 10%, 20%, 30%, 40%, 50%, 60%, 70%, 80% or 90%.

Herein, “open volume”, also known as “free volume”, is taken to mean the internal volume of a microporous membrane that is not occupied by the material from which the membrane is constructed. For the avoidance of doubt, this is the percentage of space available to be occupied by a fluid such as air or such as a solution of a colour former or both.

Aptly, the microporous membrane may be prepared by any means known to the skilled artisan, such as casting, melt blowing or extruding.

Aptly, the microporous membrane is constructed of a polymeric material, including but not limited to one or more of the following: poly(ethersulfone), poly(sulfone), poly(vinyldifluoride), poly(vinyl chloride), cellulose, chemically modified cellulose (such as nitrocellulose or cellulose ester), poly(carbonate), poly(tetrafluoroethylene), poly(propylene), poly(ethylene), poly(ethylene terephthalate), poly(urethane), acrylic copolymer or nylon.

Aptly, the microporous membrane has an average pore size within the range 0.1-5.0 micrometres. Aptly, the average pore size is an average pore diameter.

More aptly, the microporous membrane has an average pore size within the range 0.1-1.2 micrometres, for example 0.10, 0.20, 0.22, 0.30, 0.45, 0.65, 0.80, 1.0 or 1.2 micrometres.

Aptly, the microporous membrane has a thickness within the range 10-1000 micrometres.

More aptly, the microporous membrane has a thickness within the range 50-300 micrometres. Aptly, the membrane may have a uniform or asymmetric pore structure. In certain embodiments, asymmetric membranes have a gradient of pore size that varies uniformly from one major face to the other. Typically the pore size at one face can be 20 to 100 times greater than that at the other. More aptly, the membrane has a uniform pore structure.

Apt membranes, as described above are supplied commercially by PALL Life Sciences (PALL Corporation) under such trade names as Versapor, VersaporR and Supor, by PIL Membranes Ltd under the product codes: P330, P345 and P355 for example, and by Hangzhou ANOW Microfiltration Co., Ltd.

Aptly, the microporous membrane is associated, on one major face, with a sheet material impermeable to the colour former solution. The associated sheet material may be associated with the microporous membrane by adhesive means or by mechanical means or both. Association of the sheet materials may be achieved by hot or cold roll lamination. This association is desirable because it ensures that test articles are at no risk of contamination with the impregnated colour former solution.

Aptly, the associated sheet has a thickness within the range 5-250 micrometres.

Aptly, the associated sheet is transparent or is opaque.

Aptly, the associated sheet is coloured.

Aptly, the associated sheet is constructed of a polymeric material, including but not limited to one or more of the following: poly(ethylene terephthalate), poly(urethane), poly(propylene), poly(ethylene), poly(carbonate) or poly(styrene).

Aptly, when the associated sheet is associated by means of an adhesive layer, the adhesive is a hot-melt adhesive or a pressure sensitive adhesive.

Aptly, when the adhesive is a pressure sensitive adhesive, it is an acrylic adhesive.

Apt adhesive coated sheets are available from Coveris Advanced Coatings Ltd under the Inspire trade name and Scapa Group PLC under, for example, the part number 6016/877.

Aptly, when the adhesive is a hot-melt adhesive, it is an ethyl vinyl acetate adhesive. Apt hot-melt lamination film is available from GBC (Acco Brands Corp.) under the EZLoad brand and D&K Europe Ltd under the ADB Gloss brand.

Aptly, the overall thickness of the microporous membrane and associated sheet is in the range 10-500 micrometres.

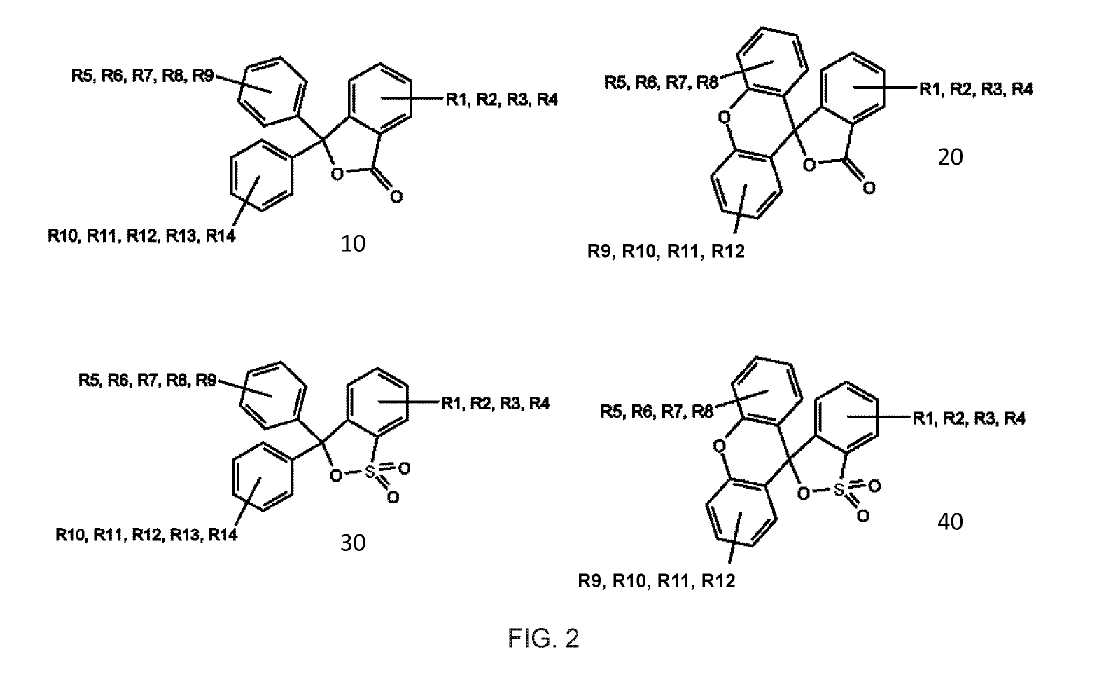

Aptly, the colour former is a phthalide-based, fluoran-based, sulfophthalide-based or sulfofluoran-based leuco dye, the structures of which are depicted in FIG. 2.

Referring to FIG. 2, when the colour former is a phthalide-based molecule (10), it may have any substituent group, labelled R1-14, wherein some or all of R1-R14 may be the same or may vary independently. R1-R14 may be any chemical group, including but not limited to a proton or an alkyl or aryl substituent. When the substituent is an alkyl or aryl group, it may include elements in addition to carbon and hydrogen; for example, but not limited to sulphur, nitrogen, oxygen or any halide.

Referring to FIG. 2, when the colour former is a fluoran-based molecule (20), it may have any substituent group, labelled R1-12, wherein some or all of R1-R12 may be the same or may vary independently. R1-R12 may be any chemical group, including but not limited to a proton or an alkyl or aryl substituent. When the substituent is an alkyl or aryl group, it may include elements in addition to carbon and hydrogen; for example, but not limited to sulphur, nitrogen, oxygen or any halide.

Referring to FIG. 2, when the colour former is a sulfophthalide-based molecule (30), it may have any substituent group, labelled R1-14, wherein some or all of R1-R14 may be the same or may vary independently. R1-R14 may be any chemical group, including but not limited to a proton or an alkyl or aryl substituent. When the substituent is an alkyl or aryl group, it may include elements in addition to carbon and hydrogen; for example, but not limited to sulphur, nitrogen, oxygen or any halide.

Referring to FIG. 2, when the colour former is a sulfofluoran-based molecule (40), it may have any substituent group, labelled R1-12, wherein some or all of R1-R12 may be the same or may vary independently. R1-R12 may be any chemical group, including but not limited to a proton or an alkyl or aryl substituent. When the substituent is an alkyl or aryl group, it may include elements in addition to carbon and hydrogen; for example, but not limited to sulphur, nitrogen, oxygen or any halide.

Aptly, the colour former is chosen from those listed at paragraph [0022] of US Patent Publication 2007/0207925, the contents of which are incorporated herein by reference in their entirety.

Aptly, the colour former is chosen from one or more of the following:
[CAS 29512-99-0] 2-Phenylamino-3-methyl-6-diethylaminofluorane,
[CAS 89331-94-2] 3-di-n-Butylamino-6-methyl-7-phenylaminofluorane,
[CAS 36431-22-8] 2-(2′, 4′-dimethylphenylamino-3-methyl-6-diethylaminofluorane),
[CAS 1522-42-7] 3,3-bis(p-(dimethylamino)phenyl)-6-(dimethylamino)phthalide,
[CAS 50292-95-0] 3-Diethylaminobenzofluorane,
[CAS 154306-60-2] Ethyl 6′-(diethylamino)-3-oxospiro[2-benzofuran-1,9′-xanthene]-2′-carboxylate,
[CAS 87563-89-1] 7-[4-(Diethylamino)-2-ethoxyphenyl]-7-(2-methyl-1-octyl-1H-indol-3-yl)furo[3,4-b]pyridin-5(7H)-one,
[CAS 34372-72-0] 2-Di(phenylmethyl)amine-6′-diethylaminospiro(isobenzofuran-1(3H), 9′-[9H] xanthen-3-one,
[CAS 70516-41-5] 3-(N-ethyl-N-isopentylamino)-6-methyl-7-anilinofluorane,
[CAS 26628-47-7] 6′-(Diethylamino)-1′,2′-benzofluoran, and
[CAS 69898-40-4] 7-(4-(Diethylamino)-2-ethoxyphenyl)-7-(1-ethyl-2-methyl-1H-indol-3-yl) furo[3,4-b]pyridin-5(7H)-one.

Apt colour formers, as described above, are supplied commercially by Connect Chemicals GmbH under the WinCon trade name and Chameleon Specialty Chemicals Ltd under the Chameleon trade name.

Aptly, the colour former is dissolved in a liquid to produce a colour former solution.

Aptly, the colour former comprises in the range of 1-80% of the total weight of the solution. More aptly, the colour former comprises in the range of 10-60% of the total weight of the solution.

Aptly, the liquid in which the colour former is dissolved can be any organic liquid, including but not limited to, natural and mineral oils. The aforementioned prior art describes suitable liquids exhaustively.

Aptly, the liquid has a vapour pressure below 0.25 PSI (pounds per square inch) at 38° C. and a melting point below 25° C.

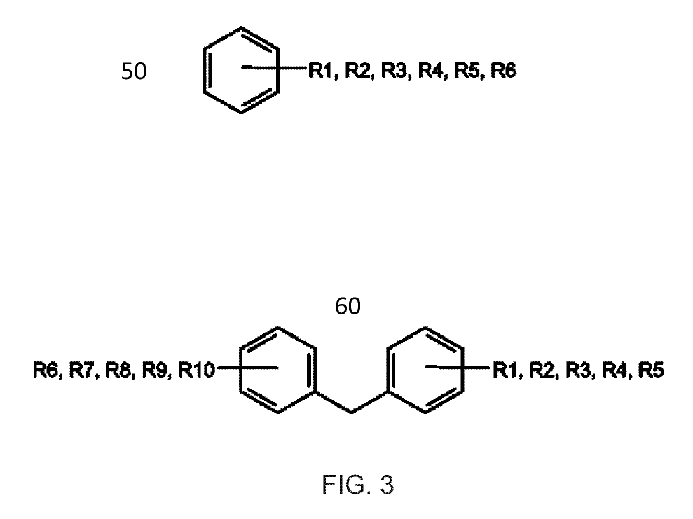

Aptly, the liquid is chosen from: cotton seed oil, mineral oil, silicone oil, vegetable or fruit oil (including limonene) and any liquid based on the structures of benzene or biphenyl, refer to FIG. 3.

Referring to FIG. 3, when liquid is a benzene-based molecule (50), it may have any substituent group, labelled R1-6, wherein some or all of R1-R6 may be the same or may vary independently. R1-R6 may be any chemical group, including but not limited to a proton or an alkyl or aryl substituent. When the substituent is an alkyl or aryl group, it may include elements in addition to carbon and hydrogen; for example, but not limited to sulphur, nitrogen, oxygen or any halide.

Referring to FIG. 3, when liquid is a biphenyl-based molecule (60), it may have any substituent group, labelled R1-10, wherein some or all of R1-R10 may be the same or may vary independently. R1-R10 may be any chemical group, including but not limited to a proton or an alkyl or aryl substituent. When the substituent is an alkyl or aryl group, it may include elements in addition to carbon and hydrogen; for example, but not limited to sulphur, nitrogen, oxygen or any halide.

Aptly, the liquid is a mixture of substituted aromatic hydrocarbons, including but not limited to di-isopropylbiphenyls, tri-isopropylbiphenyls, isopropyl-1,1-diphenylethane and isopropyl-1,2-diphenylethane.

Apt liquids, as described above, are supplied commercially by JX Nippon Chemicals Texas Inc. under the product names SAS-305 and SS-300.

The viscosity of the colour former solution can be modified by apt choice of solvent liquid and/or the addition of a viscosity modifying agent. Aptly, a viscosity increasing material may be solubilised in the liquid, in addition to the colour former.

Suitable viscosity increasing materials include, but are not limited to: styrene-ethylene/butylene-styrene (SEBS) copolymers and styrene-ethylene-propylene (SEP) copolymers.

Suitable viscosity increasing materials, as described above, are supplied commercially by Kraton Performance Polymers Inc. under the Kraton G SEBS and SEPS trade names, and Versalis S.p.A. under the Europrene trade name.

Aptly, when a viscosity increasing material is included in the colour former solution, it is present in the range 1-50% of the total weight of the solution. More aptly, it is present in the range 1-20% of the total weight of the solution.

Aptly the viscosity of the colour former solution lies in the range 1×10⁻⁴ to about 1×10⁷ Pa·s (Pascal seconds).

Aptly the viscosity of the colour former solution lies in the range 1.0×10⁻⁴ to about 1000 Pa·s (Pascal seconds).

Aptly the viscosity of the colour former solution lies in the range 1 to about 1×10⁷ Pa·s (Pascal seconds).

Aptly, the colour former solution is present in the range 1-95% of the total weight of the final product.

Aptly, 10-100% of the open volume of the microporous membrane is occupied by the colour former solution.

More aptly, 50-100% of the open volume of the microporous membrane is occupied by the colour former solution.

Aptly, the viscosity increasing material is dissolved in the solvent liquid prior to the colour former.

A second aspect of this invention is a pressure recording means comprising two sheet materials, the first of which comprises a microporous membrane within which is associated a solution of a colour former and the second of which comprises a colour developer.

Aptly, the first sheet material is as described in the first aspect of the present invention.

The second sheet material, comprising a colour developer, may be any disclosed in the prior art. Commonly, the colour developer is an acidic solid such as an acid-exchanged clay or silica.

Aptly, the colour developer is chosen from one or more of the following: bentonite, attapulgite, zeolite, acid clay, silica or any organic acid, including salicylate salts, sulfonic acids and naphthols.

Apt silica colour developers, as described above, are supplied commercially, as coating solutions, by Evonik Industries AG under the Aerodisp trade name.

Aptly, the colour developer sheet comprises silica and a binding agent.

Apt binding agents include but are not limited to gelatin, guar gum, carrageenan, poly(vinyl alcohol), poly(olefin), styrene-butadiene rubber (SBR) latexes and ethylene acrylic acid dispersions. The latter are supplied commercially under the Michem Prime trade name by Michelman Inc.

Apt colour developer sheets are available from PPG Industries, Inc. under the Teslin brand. Teslin is a silica-filled poly(olefin)-based microporous sheet.

A further aspect of this invention is a process for the impregnation of a microporous membrane with a solution comprising a colour former that comprises: diluting the colour former solution in a volatile solvent, impregnating the microporous membrane with the resulting solution and removing the volatile solvent.

In this way, colour former solutions can be rapidly and uniformly distributed within the pores of the microporous membrane, even at low loading percentage weights.

Apt volatile diluents are organic solvents including but not limited to one or more of the following: acetone, toluene, cyclohexane, ethanol, methanol, iso-propanol, chloroform, dichloromethane, ethyl acetate and diethyl ether.

The colour former solution may be diluted in the volatile solvent at a concentration in the range 1-90% of the total weight.

The membrane may be impregnated with the resulting solution by any means, including but not limited to one or more of the following: spraying, padding, printing, transfer coating, slit coating, air-knife coating or dip coating.

Aptly, 10-100% of the open volume of the microporous membrane is occupied by the loading solution.

More aptly, 50-100% of the open volume of the microporous membrane is occupied by the loading solution.

Aptly, the volatile solvent may be removed by heating means, reduced pressure or both.

Aptly, removing the volatile solvent comprises heating the article and/or applying a reduced pressure thereto and/or evaporating the solvent at ambient temperature (e.g. about 18-25° C.) or elevated temperature (e.g. about 50-200° C.).

A further aspect of this invention is a means of storing a microporous membrane within which is associated a solution comprising a colour former. The material may need to be stored for several years prior to use and be stored for several years between uses. Solvent-loss from microcapsule-based products such as Fuji Prescale is well known and limits storage temperature and shelf-life. Certain embodiments of the present invention are considered to suffer to a lesser degree from solvent loss because there is substantially more solvent present in the final product at the time of manufacture. Notwithstanding this, solvent loss on storage is undesirable per se. To reduce solvent loss on storage to a minimum, the microporous membrane within which is associated a solution comprising a colour former can be optionally stored within a highly impermeable barrier pouch enclosure.

Apt highly impermeable barrier materials for pouch construction include, but are not limited to, Tyvek (E. I. du Pont de Nemours and Company), Aclar (Honeywell International Inc.) and aluminium foil laminates, for example poly(ethylene terephthalate)-aluminium foil-poly(propylene) trilaminate pouches.

For storage after opening, a zip-loc style closure means is apt. Aptly, this may be a single or double closure system.

The pressure imaging means of certain embodiments of the invention can be applied for the imaging of pressure distribution between surfaces. Application areas include, but are not limited to: machine component interfaces including engine, gear box, turbine, valve, pump, hydraulic cylinder and compressor parts; roller contact surfaces in coating machines, paper mills and printing presses; mold mating interfaces; impact pressure visualisation; car tyre tread pattern and wear visualisation; medical visualisation of orthotic pressure (e.g. of insole inserts); television screen assembly process validation.

Thus, in certain embodiments the pressure imaging means is a device for imaging vehicle tyre pattern and wear.

In a further aspect of the present invention, there is provided a method of determining a pressure, the method comprising:
a) providing the pressure imaging means as described herein;
b) applying a force to the pressure imaging means;
c) removing the force from the pressure imaging means; and
d) imaging the pressure imaging means.

Aptly, the method further comprises digitising the image and converting this data into a multi-coloured pressure profile map, as described in US2014/0043476.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

There now follows a series of specific embodiments of the invention. These specific embodiments do not restrict the scope of the invention.

### EXAMPLES

### Example 1 Preparation of Nitrocellulose Microporous Membrane within which is Associated a Solution Comprising a Red Colour Former

20 ml of a 20% w/w solution of Chameleon Red 5 (Chameleon Specialty Chemicals Ltd) was made up in SAS-305 (JX Nippon Chemicals Texas Inc.). A 10×10 cm square sheet of 0.45 micrometre pore size nitrocellulose membrane (Whatman NC-45) was fully immersed in the solution. The membrane turned transparent and pink in colour. Care was taken to avoid air-locking portions of the membrane during immersion. The membrane was removed from the solution and dried between absorbent tissue layers with light pressure.

### Example 2 Preparation of Nitrocellulose Microporous Membrane within which is Associated a Solution Comprising a Blue Colour Former

20 ml of a 20% w/w solution of Crystal violet lactone (Chameleon Specialty Chemicals Ltd) was made up in SAS-305 (JX Nippon Chemicals Texas Inc.). A 10×10 cm square sheet of 0.45 micrometre pore size nitrocellulose membrane (Whatman NC-45) was fully immersed in the solution. The membrane turned transparent and blue in colour. Care was taken to avoid air-locking portions of the membrane during immersion. The membrane was removed from the solution and dried between absorbent tissue layers with light pressure.

### Example 3 Preparation of Nitrocellulose Microporous Membrane within which is Associated a Solution Comprising a Green Colour Former

20 ml of a 20% w/w solution of WinCon Green (Connect Chemicals GmbH) was made up in SAS-305 (JX Nippon Chemicals Texas Inc.). A 10×10 cm square sheet of 0.45 micrometre pore size nitrocellulose membrane (Whatman NC-45) was fully immersed in the solution. The membrane turned transparent and green in colour. Care was taken to avoid air-locking portions of the membrane during immersion. The membrane was removed from the solution and dried between absorbent tissue layers with light pressure.

### Example 4 Preparation of Nitrocellulose Microporous Membrane within which is Associated a Solution Comprising a Black Colour Former

20 ml of a 20% w/w solution of WinCon-1 (Connect Chemicals GmbH) was made up in SAS-305 (JX Nippon Chemicals Texas Inc.). A 10×10 cm square sheet of 0.45 micrometre pore size nitrocellulose membrane (Whatman NC-45) was fully immersed in the solution. The membrane turned transparent and grey in colour. Care was taken to avoid air-locking portions of the membrane during immersion. The membrane was removed from the solution and dried between absorbent tissue layers with light pressure.

### Example 5 Preparation of Nitrocellulose Microporous Membrane within which is Associated a Solution Comprising an Orange Colour Former

20 ml of a 20% w/w solution of Chameleon Orange (Chameleon Specialty Chemicals Ltd) was made up in SAS-305 (JX Nippon Chemicals Texas Inc.). A 10×10 cm square sheet of 0.45 micrometre pore size nitrocellulose membrane (Whatman NC-45) was fully immersed in the solution. The membrane turned transparent and orange in colour. Care was taken to avoid air-locking portions of the membrane during immersion. The membrane was removed from the solution and dried between absorbent tissue layers with light pressure.

### Example 6 Preparation of Nitrocellulose Microporous Membrane within which is Associated a Solution Comprising a Red Colour Former; 20% Solvent Dilution Loading

20 ml of a 20% w/w solution of Chameleon Red 5 (Chameleon Specialty Chemicals Ltd) was made up in SAS-305 (JX Nippon Chemicals Texas Inc.). To this solution, 5 ml toluene was added. A 10×10 cm square sheet of 0.45 micrometre pore size nitrocellulose membrane (Whatman NC-45) was fully immersed in the diluted solution. The membrane turned transparent and pink in colour. Care was taken to avoid air-locking portions of the membrane during immersion. The membrane was removed from the solution and dried between absorbent tissue layers with light pressure prior to oven drying at 70° C. for 1 hour.

### Example 7 Preparation of Nitrocellulose Microporous Membrane within which is Associated a Solution Comprising a Red Colour Former; 50% Solvent Dilution Loading

20 ml of a 20% w/w solution of Chameleon Red 5 (Chameleon Specialty Chemicals Ltd) was made up in SAS-305 (JX Nippon Chemicals Texas Inc.). To this solution, 20 ml toluene was added. A 10×10 cm square sheet of 0.45 micrometre pore size nitrocellulose membrane (Whatman NC-45) was fully immersed in the diluted solution. The membrane turned transparent and pink in colour. Care was taken to avoid air-locking portions of the membrane during immersion. The membrane was removed from the solution and dried between absorbent tissue layers with light pressure prior to oven drying at 70° C. for 1 hour.

### Example 8 Preparation of Nitrocellulose Microporous Membrane within which is Associated a Solution Comprising a Red Colour Former; 80% Solvent Dilution Loading

20 ml of a 20% w/w solution of Chameleon Red 5 (Chameleon Specialty Chemicals Ltd) was made up in SAS-305 (JX Nippon Chemicals Texas Inc.). To this solution, 80 ml toluene was added. A 10×10 cm square sheet of 0.45 micrometre pore size nitrocellulose membrane (Whatman NC-45) was fully immersed in the diluted solution. The membrane turned transparent and pink in colour. Care was taken to avoid air-locking portions of the membrane during immersion. The membrane was removed from the solution and dried between absorbent tissue layers with light pressure prior to oven drying at 70° C. for 1 hour.

### Example 9 Preparation of 0.45 um Poly(Ethersulfone) Microporous Membrane within which is Associated a Solution Comprising a Red Colour Former; 20% Solvent Dilution Loading

20 ml of a 20% w/w solution of Chameleon Red 5 (Chameleon Specialty Chemicals Ltd) was made up in SAS-305 (JX Nippon Chemicals Texas Inc.). To this solution, 5 ml toluene was added. A 10×10 cm square sheet of 0.45 micrometre pore size poly(ethersulfone) membrane (PALL Life Sciences, Supor) was fully immersed in the diluted solution. The membrane turned transparent and pink in colour. Care was taken to avoid air-locking portions of the membrane during immersion. The membrane was removed from the solution and dried between absorbent tissue layers with light pressure prior to oven drying at 70° C. for 1 hour, resulting in an opaque white sheet, similar in appearance to the untreated membrane.

### Example 10 Preparation of 0.80 um Poly(Ethersulfone) Microporous Membrane within which is Associated a Solution Comprising a Red Colour Former; 20% Solvent Dilution Loading

20 ml of a 20% w/w solution of Chameleon Red 5 (Chameleon Specialty Chemicals Ltd) was made up in SAS-305 (JX Nippon Chemicals Texas Inc.). To this solution, 5 ml toluene was added. A 10×10 cm square sheet of 0.80 micrometre pore size poly(ethersulfone) membrane (PALL Life Sciences, Supor) was fully immersed in the diluted solution. The membrane turned transparent and pink in colour. Care was taken to avoid air-locking portions of the membrane during immersion. The membrane was removed from the solution and dried between absorbent tissue layers with light pressure prior to oven drying at 70° C. for 1 hour, resulting in an opaque white sheet, similar in appearance to the untreated membrane.

### Example 11 Preparation of 1.20 um Poly(Ethersulfone) Microporous Membrane within which is Associated a Solution Comprising a Red Colour Former; 20% Solvent Dilution Loading

20 ml of a 20% w/w solution of Chameleon Red 5 (Chameleon Specialty Chemicals Ltd) was made up in SAS-305 (JX Nippon Chemicals Texas Inc.). To this solution, 5 ml toluene was added. A 10×10 cm square sheet of 1.20 micrometre pore size poly(ethersulfone) membrane (PALL Life Sciences, Supor) was fully immersed in the diluted solution. The membrane turned transparent and pink in colour. Care was taken to avoid air-locking portions of the membrane during immersion. The membrane was removed from the solution and dried between absorbent tissue layers with light pressure prior to oven drying at 70° C. for 1 hour, resulting in an opaque white sheet, similar in appearance to the untreated membrane.

### Example 12 Preparation of Poly(Vinyldifluoride) Microporous Membrane within which is Associated a Solution Comprising a Red Colour Former; 20% Solvent Dilution Loading

20 ml of a 20% w/w solution of Chameleon Red 5 (Chameleon Specialty Chemicals Ltd) was made up in SAS-305 (JX Nippon Chemicals Texas Inc.). To this solution, 5 ml toluene was added. A 10 cm diameter circular sheet of 0.45 micrometre pore size poly(vinyldifluoride) membrane (Hangzhou ANOW Microfiltration Co., Ltd) was fully immersed in the diluted solution. The membrane turned transparent. Care was taken to avoid air-locking portions of the membrane during immersion. The membrane was removed from the solution and dried between absorbent tissue layers with light pressure prior to oven drying at 70° C. for 1 hour, resulting in an opaque white sheet, similar in appearance to the untreated membrane.

### Example 13 Preparation of Hydrophobic Acrylic Copolymer Microporous Membrane within which is Associated a Solution Comprising a Red Colour Former; 20% Solvent Dilution Loading

20 ml of a 20% w/w solution of Chameleon Red 5 (Chameleon Specialty Chemicals Ltd) was made up in SAS-305 (JX Nippon Chemicals Texas Inc.). To this solution, 5 ml toluene was added. A 10 cm diameter circular sheet of 0.45 micrometre pore size Versapor R membrane (PALL Life Sciences) was fully immersed in the diluted solution. The membrane turned transparent. Care was taken to avoid air-locking portions of the membrane during immersion. The membrane was removed from the solution and dried between absorbent tissue layers with light pressure prior to oven drying at 70° C. for 1 hour, resulting in an opaque white sheet, similar in appearance to the untreated membrane.

### Example 14 Preparation of Hydrophilic Acrylic Copolymer Microporous Membrane within which is Associated a Solution Comprising a Red Colour Former; 20% Solvent Dilution Loading

20 ml of a 20% w/w solution of Chameleon Red 5 (Chameleon Specialty Chemicals Ltd) was made up in SAS-305 (JX Nippon Chemicals Texas Inc.). To this solution, 5 ml toluene was added. A 10 cm diameter circular sheet of 0.45 micrometre pore size Versapor membrane (PALL Life Sciences) was fully immersed in the diluted solution. The membrane turned transparent. Care was taken to avoid air-locking portions of the membrane during immersion. The membrane was removed from the solution and dried between absorbent tissue layers with light pressure prior to oven drying at 70° C. for 1 hour, resulting in an opaque white sheet, similar in appearance to the untreated membrane.

### Example 15 Preparation of 0.45 um Poly(Ethersulfone) Microporous Membrane within which is Associated a Thickened Solution Comprising a Red Colour Former; 50% Solvent Dilution Loading

20 ml of a 20% w/w solution of Europrene SOL TH 2312 (Verasalis S.p.A.) was made up in SAS-305 (JX Nippon Chemicals Texas Inc.). The mixture was heated in a sealed vessel at 70° C. overnight to allow full dissolution to occur. To the viscous solution, 5 g of Chameleon Red 5 (Chameleon Specialty Chemicals Ltd) was added and the mixture held at 70° C., with periodic stirring, until full dissolution occurred, resulting is a viscous yellow solution. To this solution, 20 ml toluene was added and mixed until homogeneous. A 10×10 cm square sheet of 0.45 micrometre pore size poly(ethersulfone) membrane (PALL Life Sciences, Supor) was fully immersed in the diluted solution. The membrane turned transparent and pink in colour. Care was taken to avoid air-locking portions of the membrane during immersion. The membrane was removed from the solution and dried between absorbent tissue layers with light pressure prior to oven drying at 70° C. for 1 hour, resulting in an opaque white sheet, similar in appearance to the untreated membrane.

### Example 16 Preparation of a Colour Developer Layer

The method of coating described in the examples of U.S. 61/114,022 was applied to a poly(ethylene terephthalate) film of 36 micrometres in thickness. The silica-based formulation was spread at a wet thickness of 10 micrometres using a slit. The wet coating was dried using infra-red heat lamps. The coating was uniform, opaque, flexible and free from macroscopic cracks.

### Example 17 Mechanical Testing of Microporous Membrane-Based Thickened Red Colour Former Sheet with Silica-Based Colour Developer Layer

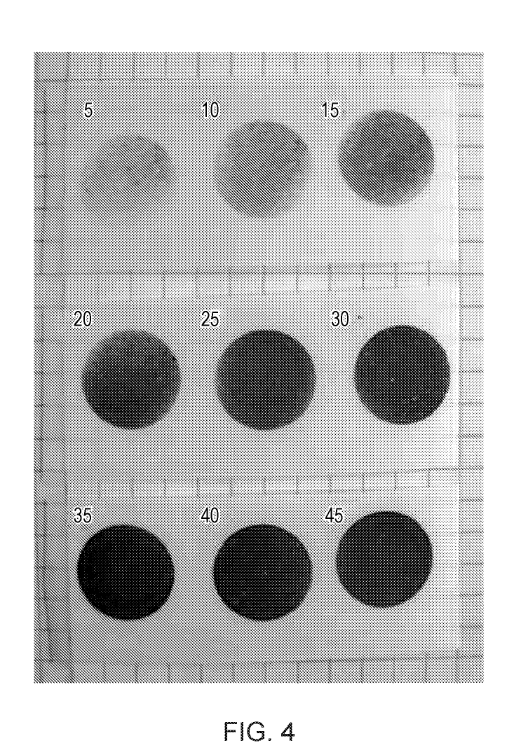

The sheet material produced in Example 15 was placed upon the silica-coated surface of FujiFilm Prescale C-film. The associated sheets were compressed between highly polished stainless steel dies of defined diameter (Across International L.L.C.) under a series of precise forces generated by a Chatillon HTC test stand and a Chatillon Ametek DFX II, 500 N force gauge. Images were recorded under each force and the force was converted into a pressure. FIG. 4 shows a grey-scale scanned image of the test results. The images demonstrate that this combination of material sheets results in a pressure imaging material that is sensitive to pressures as low as 2.8 kg/cm² and shows a proportionate colour response up to a pressure of around 17.0 kg/cm², above which a consistent colour is developed.

### Example 18 Mechanical Testing of Microporous Membrane-Based Red Colour Former Sheet with Silica-Based Colour Developer Layer

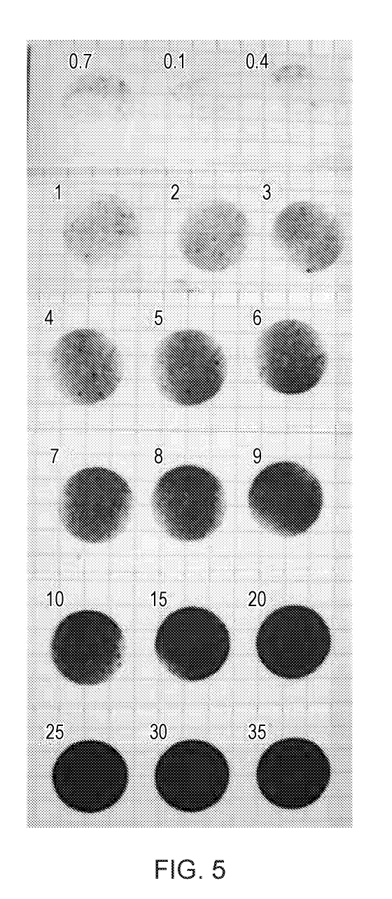

The sheet material produced in Example 7 was placed upon the silica-coated surface of FujiFilm Prescale C-film. The associated sheets were compressed between highly polished stainless steel dies of defined diameter (Across International L.L.C.) under a series of precise forces generated by a Chatillon HTC test stand and a Chatillon Ametek DFX II, 500 N force gauge. Images were recorded under each force and the force was converted into a pressure. FIG. 5 shows a grey-scale scanned image of the test results. The images demonstrate that this combination of material sheets results in a pressure imaging material that is sensitive to pressures as low as 0.23 kg/cm² and shows a proportionate colour response up to a pressure of around 8.5 kg/cm², above which a consistent colour is developed.

### Example 19 Mechanical Testing of Microporous Membrane-Based Red Colour Former Sheet with Silica-Based Colour Developer Layer

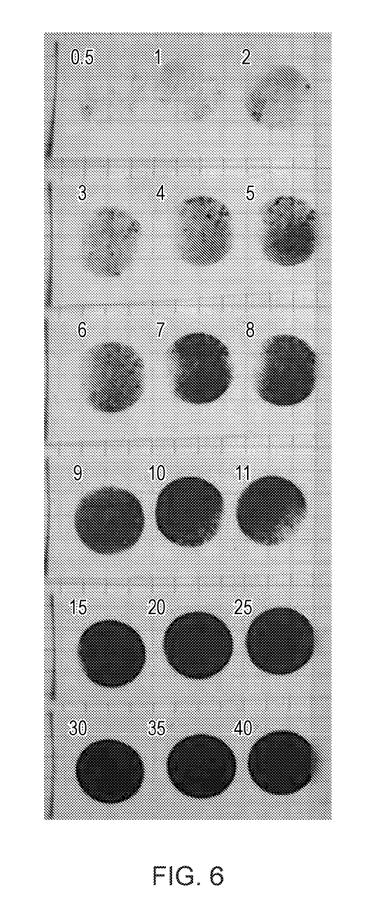

The sheet material produced in Example 9 was placed upon the silica-coated surface of FujiFilm Prescale C-film. The associated sheets were compressed between highly polished stainless steel dies of defined diameter (Across International L.L.C.) under a series of precise forces generated by a Chatillon HTC test stand and a Chatillon Ametek DFX II, 500 N force gauge. Images were recorded under each force and the force was converted into a pressure. FIG. 6 shows a grey-scale scanned image of the test results. The images demonstrate that this combination of material sheets results in a pressure imaging material that is sensitive to pressures as low as 0.57 kg/cm² and shows a proportionate colour response up to a pressure of around 8.5 kg/cm², above which a consistent colour is developed.

### Example 20 Mechanical Testing of Microporous Membrane-Based Red Colour Former Sheet with Silica-Based Colour Developer Layer; Examination of the Effect of Varying the Loading of the Colour Former Solution within the Microporous Membrane

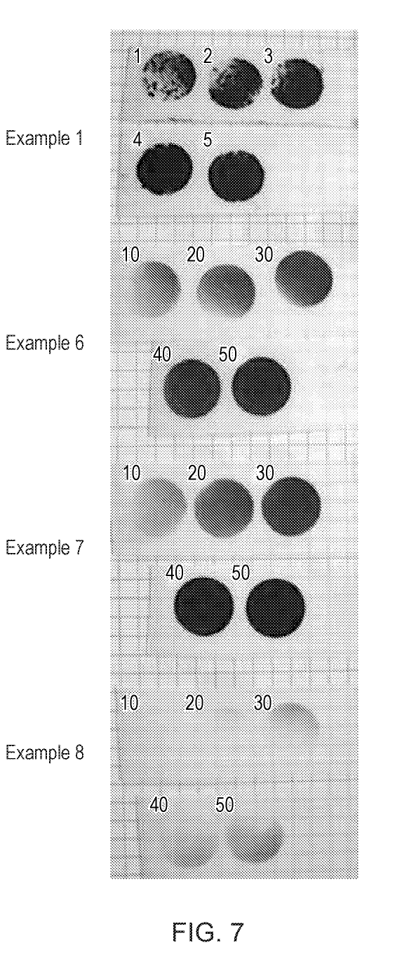

The sheet materials produced in Examples 1, 6, 7, and 8 were placed upon the silica-coated surface of FujiFilm Prescale C-film. The associated sheets were compressed between highly polished stainless steel dies of defined diameter (Across International L.L.C.) under a series of precise forces generated by a Chatillon HTC test stand and a Chatillon Ametek DFX II, 500 N force gauge. Images were recorded under each force and the force was converted into a pressure. FIG. 7 shows a grey-scale scanned image of the test results. The images demonstrate that, as the colour former solution loading within the microporous membrane is decreased, a greater pressure is required to generate colour development. We generated material combinations that responded only to pressures exceeding 500 kg/cm² using this method.

### Example 21 Mechanical Testing of Microporous Membrane-Based Red Colour Former Sheet with Silica-Based Colour Developer Layer; Examination of Image Resolution Using a British One Pound (£1) Coin

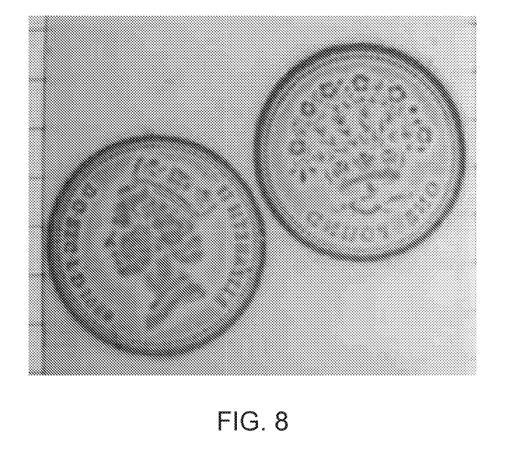

The sheet material produced in Example 6 was placed upon the silica-coated surface of FujiFilm Prescale C-film. The associated sheets were compressed between a British £1 coin and a slab of Shore A hardness silicone rubber, applying thumb pressure (approximately 10 kg/cm²). An image was recorded for each coin face. FIG. 8 shows a grey-scale scanned image of the test results. The images demonstrate that this combination of materials generates excellent spatial resolution in comparison to materials of the prior art.

### Example 22 Mechanical Testing of Microporous Membrane-Based Red Colour Former Sheet with Silica-Based Colour Developer Layer; Examination of the Effect of Varying the Microporous Membrane Pore Size

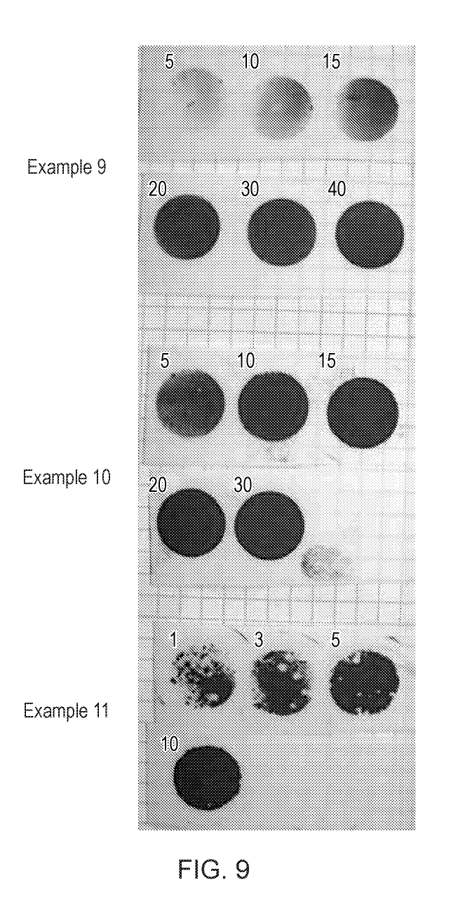

The sheet materials produced in Examples 9, 10, and 11 were placed upon the silica-coated surface of FujiFilm Prescale C-film. The associated sheets were compressed between highly polished stainless steel dies of defined diameter (Across International L.L.C.) under a series of precise forces generated by a Chatillon HTC test stand and a Chatillon Ametek DFX II, 500 N force gauge. Images were recorded under each force and the force was converted into a pressure. FIG. 9 shows a grey-scale scanned image of the test results. The images demonstrate that, as the pore size of the microporous membrane is increased, the pressure threshold at which colour develops decreases. Given the available pore size range, it can be estimated that pore size alone can generate a shift in pressure threshold of about one order of magnitude.

### Example 23 Preparation of a Bilaminate Material Comprising 0.45 um Poly(Ethersulfone) Microporous Membrane, within which is Associated a Solution Comprising a Red Colour Former, and an Adhesive Polyurethane Film

The microporous membrane produced in Example 9 was laminated to an adhesive polyurethane film (6016/877, Scapa UK Ltd). The bilaminate material was slit into a roll format and stored in a poly(ethylene terephthalate)-aluminium foil-poly(propylene) trilaminate pouch for stability study.

### Example 24 Preparation of 0.45 um Poly(Ethersulfone) Microporous Membrane within which is Associated a Solution Comprising a Red Colour Former; 20% Solvent Dilution Loading

20 ml of a 20% w/w solution of Chameleon Red 5 (Chameleon Specialty Chemicals Ltd) was made up in SS-300 (JX Nippon Chemicals Texas Inc.). To this solution, 5 ml toluene was added. A 10×10 cm square sheet of 0.45 micrometre pore size poly(ethersulfone) membrane (PALL Life Sciences, Supor) was fully immersed in the diluted solution. The membrane turned transparent and pink in colour. Care was taken to avoid air-locking portions of the membrane during immersion. The membrane was removed from the solution and dried between absorbent tissue layers with light pressure prior to oven drying at 70° C. for 1 hour, resulting in an opaque white sheet, similar in appearance to the untreated membrane.

### Example 25 Preparation of Nitrocellulose Microporous Membrane within which is Associated a d-Limonene Solution Comprising a Red Colour Former

20 ml of a 20% w/w solution of Chameleon Red 5 (Chameleon Specialty Chemicals Ltd) was made up in d-limonene. A 10×10 cm square sheet of 0.45 micrometre pore size nitrocellulose membrane (Whatman NC-45) was fully immersed in the solution. The membrane turned transparent and pink in colour. Care was taken to avoid air-locking portions of the membrane during immersion. The membrane was removed from the solution and dried between absorbent tissue layers with light pressure.

### Example 26 Preparation of Poly(Ether Sulfone) Microporous Membrane (0.20 um Pore Size) within which is Associated a Cotton Seed Oil Solution Comprising a Red Colour Former

20 ml of a 20% w/w solution of Chameleon Red 5 (Chameleon Specialty Chemicals Ltd) was made up in cotton seed oil. The solution was diluted in 20 ml toluene. A 10×10 cm square sheet of 0.20 micrometre pore size poly(ether sulfone) membrane (PALL Life Sciences, Supor) was fully immersed in the solution. The membrane turned transparent. Care was taken to avoid air-locking portions of the membrane during immersion. The membrane was removed from the solution and dried between absorbent tissue layers with light pressure, resulting in an opaque white sheet, similar in appearance to the untreated membrane.

### Example 27 Preparation of Poly(Ether Sulfone) Microporous Membrane within which is Associated a SS-300 Solution Comprising a Red Colour Former

20 ml of a 20% w/w solution of Chameleon Red 5 (Chameleon Specialty Chemicals Ltd) was made up in SS-300 (JX Nippon Chemicals Texas Inc.). The solution was diluted in 20 ml toluene. A 10×10 cm square sheet of 0.20 micrometre pore size poly(ether sulfone) membrane (PALL Life Sciences, Supor) was fully immersed in the solution. The membrane turned transparent. Care was taken to avoid air-locking portions of the membrane during immersion. The membrane was removed from the solution and dried between absorbent tissue layers with light pressure, resulting in an opaque white sheet, similar in appearance to the untreated membrane.

### Example 28 Preparation of a Bilaminate Material Comprising 0.20 um Poly(Ethersulfone) Microporous Membrane, within which is Associated a Solution Comprising a Red Colour Former, and a Hot-Melt Adhesive Film

The microporous membrane produced in Example 27 was laminated to a hot-melt adhesive laminating film (ADB Gloss Film, 42 micron thickness, D&K Europe Ltd) using a GBC Titan laminator with one heated nip roller (100° C.) and one unheated nip roller. The microporous membrane was in direct contact with the unheated roller. The bilaminate was mechanically stable, defect- and curl-free.

### Example 29 Preparation of Nylon Microporous Membrane within which is Associated a Solution Comprising a Red Colour Former

20 ml of a 20% w/w solution of Chameleon Red 5 (Chameleon Specialty Chemicals Ltd) was made up in cotton seed oil. The solution was diluted in 20 ml acetone. A 10 cm diameter circle of 0.20 micrometre pore size nylon membrane (Hangzhou Anow Microfiltration Co., Ltd.) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 30 Preparation of 0.22 um Polypropylene Microporous Membrane within which is Associated a Solution Comprising a Red Colour Former

20 ml of a 20% w/w solution of Chameleon Red 5 (Chameleon Specialty Chemicals Ltd) was made up in SS-300 (JX Nippon Chemicals Texas Inc.). The solution was diluted in 20 ml toluene. A 10 cm diameter circle of 0.22 micrometre pore size polypropylene membrane (Zhengzhou Toper Industrial Equipment Co., Ltd.) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 31 Preparation of 0.45 um Polypropylene Microporous Membrane within which is Associated a Solution Comprising a Red Colour Former

20 ml of a 20% w/w solution of Chameleon Red 5 (Chameleon Specialty Chemicals Ltd) was made up in SS-300 (JX Nippon Chemicals Texas Inc.). The solution was diluted in 20 ml toluene. A 10 cm diameter circle of 0.45 micrometre pore size polypropylene membrane (Zhengzhou Toper Industrial Equipment Co., Ltd.) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 32 Preparation of 0.80 um Polypropylene Microporous Membrane within which is Associated a Solution Comprising a Red Colour Former

20 ml of a 20% w/w solution of Chameleon Red 5 (Chameleon Specialty Chemicals Ltd) was made up in SS-300 (JX Nippon Chemicals Texas Inc.). The solution was diluted in 20 ml toluene. A 10 cm diameter circle of 0.80 micrometre pore size polypropylene membrane (Zhengzhou Toper Industrial Equipment Co., Ltd.) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 33 Preparation of 1.0 um Polypropylene Microporous Membrane within which is Associated a Solution Comprising a Red Colour Former

20 ml of a 20% w/w solution of Chameleon Red 5 (Chameleon Specialty Chemicals Ltd) was made up in SS-300 (JX Nippon Chemicals Texas Inc.). The solution was diluted in 20 ml toluene. A 10 cm diameter circle of 1.0 micrometre pore size polypropylene membrane (Zhengzhou Toper Industrial Equipment Co., Ltd.) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 34 Preparation of 1.2 um Polypropylene Microporous Membrane within which is Associated a Solution Comprising a Red Colour Former

20 ml of a 20% w/w solution of Chameleon Red 5 (Chameleon Specialty Chemicals Ltd) was made up in SS-300 (JX Nippon Chemicals Texas Inc.). The solution was diluted in 20 ml toluene. A 10 cm diameter circle of 1.2 micrometre pore size polypropylene membrane (Zhengzhou Toper Industrial Equipment Co., Ltd.) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 35 Preparation of Poly(Ether Sulfone) Microporous Membrane within which is Associated a Solution Comprising a Red Colour Former in Sunflower Oil

20 ml of a 20% w/w solution of Chameleon Red 5 (Chameleon Specialty Chemicals Ltd) was made up in sunflower oil. The solution was diluted in 20 ml toluene. A 10×10 cm square sheet of 0.65 micrometre pore size poly(ether sulfone) membrane (PALL Life Sciences, Supor) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 36 Preparation of Poly(Ether Sulfone) Microporous Membrane within which is Associated a Solution Comprising a Red Colour Former in Castor Oil

20 ml of a 20% w/w solution of Chameleon Red 5 (Chameleon Specialty Chemicals Ltd) was made up in castor oil. The solution was diluted in 20 ml toluene. A 10×10 cm square sheet of 0.65 micrometre pore size poly(ether sulfone) membrane (PALL Life Sciences, Supor) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 37 Preparation of Poly(Ether Sulfone) Microporous Membrane within which is Associated a Solution Comprising a Red Colour Former in Linseed Oil

20 ml of a 20% w/w solution of Chameleon Red 5 (Chameleon Specialty Chemicals Ltd) was made up in linseed oil. The solution was diluted in 20 ml toluene. A 10×10 cm square sheet of 0.65 micrometre pore size poly(ether sulfone) membrane (PALL Life Sciences, Supor) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 38 Preparation of Poly(Ether Sulfone) Microporous Membrane within which is Associated a Solution Comprising a Red Colour Former in Sunflower Oil (Iso-Propanol Dilution)

A temperature no less than 40° C. was maintained for all solvents throughout the loading procedure to ensure full miscibility. 20 ml of a 20% w/w solution of Chameleon Red 5 (Chameleon Specialty Chemicals Ltd) was made up in sunflower oil. The solution was diluted in 20 ml iso-propanol. A 10×10 cm square sheet of 0.65 micrometre pore size poly(ether sulfone) membrane (PALL Life Sciences, Supor) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 39 Preparation of Poly(Ether Sulfone) Microporous Membrane within which is Associated a Solution Comprising a Red Colour Former in SS-300 (Iso-Propanol Dilution)

20 ml of a 20% w/w solution of Chameleon Red 5 (Chameleon Specialty Chemicals Ltd) was made up in SS-300 (JX Nippon Chemicals Texas Inc.). The solution was diluted in 20 ml iso-propanol. A 10×10 cm square sheet of 0.65 micrometre pore size poly(ether sulfone) membrane (PALL Life Sciences, Supor) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 40 Preparation of a Bilaminate Material Comprising 0.65 um Poly(Ethersulfone) Microporous Membrane, within which is Associated a Solution Comprising a Red Colour Former, and a Hot-Melt Adhesive Film

The microporous membrane produced in Example 39 was laminated to a hot-melt adhesive laminating film (ADB Gloss Film, 42 micron thickness, D&K Europe Ltd) using a GBC Titan laminator with one heated nip roller (100° C.) and one unheated nip roller. The microporous membrane was in direct contact with the unheated roller. The bilaminate was mechanically stable, defect- and curl-free.

### Example 41 Mechanical Pressure Testing of Microporous Membrane-Based Red Colour Former Sheet with Silica-Based Colour Developer Layer (Teslin SP600)

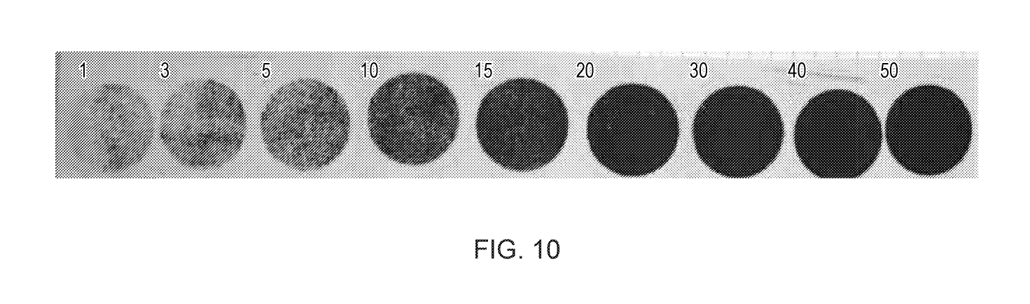

The sheet material produced in Example 40 was placed upon a sheet of Teslin SP600 (PPG Industries Inc.). The associated sheets were compressed between highly polished stainless steel dies of defined 20 mm diameter (Across International L.L.C.) under a series of precise forces generated by a Chatillon HTC test stand and a Chatillon Ametek DFX II, 500 N force gauge. Images were recorded under each force and the force was converted into a pressure. FIG. 10 shows a grey-scale scanned image of the test results. This material combination has a pressure sensitivity range of approximately 0.3-12.7 kg/cm².

### Example 42 Mechanical Resolution Testing of Microporous Membrane-Based Red Colour Former Sheet with Silica-Based Colour Developer Layer (Teslin SP600)

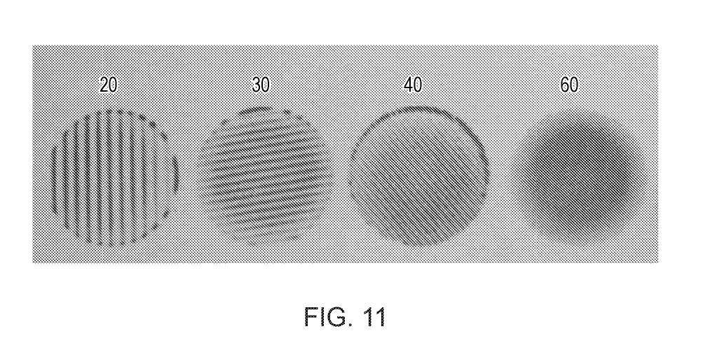

The sheet material produced in Example 40 was placed upon a sheet of Teslin SP600 (PPG Industries Inc.). The associated sheets were compressed between a highly polished stainless steel die of 15 mm diameter (Across International L.L.C.) and a plastic lenticular lens sheet of defined line spacing under a force of 15 kg generated by a Chatillon HTC test stand and a Chatillon Ametek DFX II, 500 N force gauge. A range of lenticular lens were used, with line spacings in the range 20-60 lines per inch (LPI). FIG. 11 shows a grey-scale scanned image of the test results. This material combination can resolve detail of at least 60 lines per inch (a 0.42 mm spacing). For comparison, Fuji Prescale LLLW film was unable to resolve 40 lines per inch.

### Example 43 Mechanical Resolution Testing of Microporous Membrane-Based Red Colour Former Sheet with Silica-Based Colour Developer Layer (Teslin SP600)

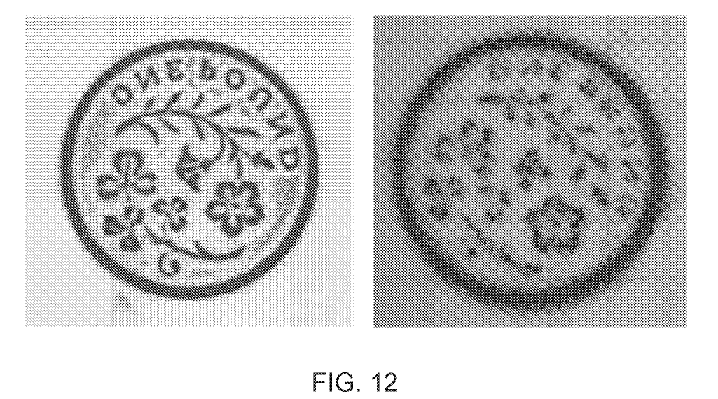

The sheet material produced in Example 40 was placed upon a sheet of Teslin SP600 (PPG Industries Inc.). The associated sheets were compressed between a British £1 coin and a flat silicone sheet of Shore A hardness under a force of 15 kg generated by a Chatillon HTC test stand and a Chatillon Ametek DFX II, 500 N force gauge. The test was repeated using Fuji Prescale LLLW film in place of the materials of the present invention. FIG. 12 shows a grey-scale scanned image of the test results. The resolution of the materials of the present invention was superior to that of the prior art.

### Example 44 Preparation of Poly(Ether Sulfone) Microporous Membrane within which is Associated a Thickened Solution Comprising a Red Colour Former in SS-300 (Cyclohexane Dilution)

200 ml of a 10% w/w solution of Chameleon Red 5 (Chameleon Specialty Chemicals Ltd) was made up in SS-300 (JX Nippon Chemicals Texas Inc.). To this solution, 40 g of Europrene SOL TH 2312 (Verasalis S.p.A.) and 440 ml cyclohexane was added. The mixture was heated at 80° C. with stirring until full dissolution occurred. A 10×10 cm square sheet of 0.20 micrometre pore size poly(ether sulfone) membrane (PALL Life Sciences, Supor) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 45 Preparation of a Bilaminate Material Comprising 0.20 um Poly(Ethersulfone) Microporous Membrane, within which is Associated a Thickened Solution Comprising a Red Colour Former, and a Hot-Melt Adhesive Film

The microporous membrane produced in Example 44 was laminated to a hot-melt adhesive laminating film (ADB Gloss Film, 42 micron thickness, D&K Europe Ltd) using a GBC Titan laminator with one heated nip roller (100° C.) and one unheated nip roller. The microporous membrane was in direct contact with the unheated roller. The bilaminate was mechanically stable, defect- and curl-free.

### Example 46 Mechanical Pressure Testing of Microporous Membrane-Based Red Colour Former Sheet with Silica-Based Colour Developer Layer (Teslin SP600)

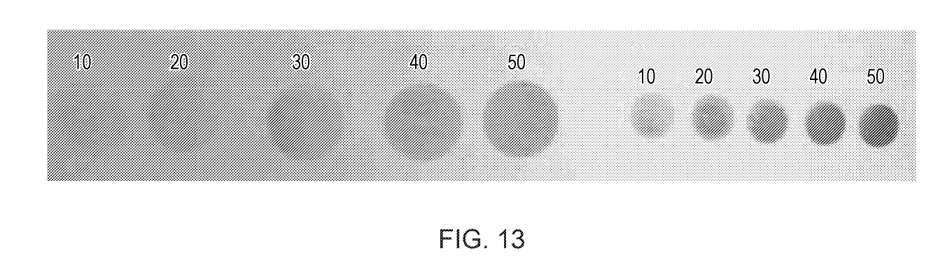

The sheet material produced in Example 45 was placed upon a sheet of Teslin SP600 (PPG Industries Inc.). The associated sheets were compressed between highly polished stainless steel dies of defined 10 mm diameter (Across International L.L.C.) under a series of precise forces generated by a Chatillon HTC test stand and a Chatillon Ametek DFX II, 500 N force gauge. Images were recorded under each force and the force was converted into a pressure. FIG. 13 shows a grey-scale scanned image of the test results. The test was repeated with 6 mm diameter stainless steel dies. This material combination has a pressure sensitivity range of approximately 20-150 kg/cm².

### Example 47 Preparation of Poly(Ether Sulfone) Microporous Membrane within which is Associated a Thickened Solution Comprising a Red Colour Former in SS-300 (Cyclohexane Dilution)

### Solution A:

200 ml of a 10% w/w solution of Chameleon Red 5 (Chameleon Specialty Chemicals Ltd) was made up in SS-300 (JX Nippon Chemicals Texas Inc.). To this solution, 40 g of Europrene SOL TH 2312 (Verasalis S.p.A.) and 440 ml cyclohexane was added. The mixture was heated at 80° C. with stirring until full dissolution occurred.

### Solution B:

200 ml of a 20% w/w solution of Chameleon Red 5 (Chameleon Specialty Chemicals Ltd) was made up in SS-300 (JX Nippon Chemicals Texas Inc.). The solution was diluted in 200 ml cyclohexane.

150 ml of Solution A was mixed with 50 ml of Solution B. The resulting solution was transparent. A 10×10 cm square sheet of 0.20 micrometre pore size poly(ether sulfone) membrane (PALL Life Sciences, Supor) was fully immersed in the resulting solution. Care was taken to avoid air-locking portions of the membrane during immersion. The membrane was removed from the solution and dried between absorbent tissue layers with light pressure, resulting in an opaque white sheet, similar in appearance to the untreated membrane.

### Example 48 Preparation of a Bilaminate Material Comprising 0.20 um Poly(Ethersulfone) Microporous Membrane, within which is Associated a Partially Thickened Solution Comprising a Red Colour Former, and a Hot-Melt Adhesive Film

The microporous membrane produced in Example 47 was laminated to a hot-melt adhesive laminating film (ADB Gloss Film, 42 micron thickness, D&K Europe Ltd) using a GBC Titan laminator with one heated nip roller (100° C.) and one unheated nip roller. The microporous membrane was in direct contact with the unheated roller. The bilaminate was mechanically stable, defect- and curl-free.

### Example 49 Mechanical Pressure Testing of Microporous Membrane-Based Red Colour Former Sheet with Silica-Based Colour Developer Layer (Teslin SP600)

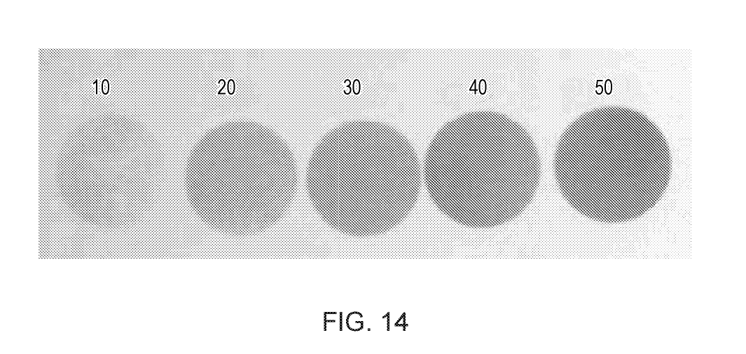

The sheet material produced in Example 48 was placed upon a sheet of Teslin SP600 (PPG Industries Inc.). The associated sheets were compressed between highly polished stainless steel dies of defined 10 mm diameter (Across International L.L.C.) under a series of precise forces generated by a Chatillon HTC test stand and a Chatillon Ametek DFX II, 500 N force gauge. Images were recorded under each force and the force was converted into a pressure. FIG. 14 shows a grey-scale scanned image of the test results. This material combination has a pressure sensitivity range of approximately 10-50 kg/cm².

Taken together, the materials of Examples 40, 45 and 48, when applied in combination with a silica-based receiver such as Teslin SP600, as reported in Examples 41, 46 and 49, are able to span the pressure range of approximately 0.3-150 kg/cm² (4-2100 pounds per square inch).

### Example 50 Preparation of Poly(Ether Sulfone) Microporous Membrane within which is Associated a Thickened Solution Comprising a Red Colour Former in SS-300

200 ml of a 10% w/w solution of Chameleon Red 5 (Chameleon Specialty Chemicals Ltd) was made up in SS-300 (JX Nippon Chemicals Texas Inc.). To this solution, 40 g of Kraton G-1650E (Kraton Performance Polymers Inc.) and 440 ml toluene was added. The mixture was heated at 80° C. with stirring until full dissolution occurred. A 10×10 cm square sheet of 0.20 micrometre pore size poly(ether sulfone) membrane (PALL Life Sciences, Supor) was fully immersed in the solution. Care was taken to avoid air-locking portions of the membrane during immersion. The membrane was removed from the solution and dried between absorbent tissue layers with light pressure, resulting in an opaque white sheet, similar in appearance to the untreated membrane.

1. A sheet material comprising a microporous membrane within which is associated a solution comprising a colour former, wherein the microporous membrane has a pore size of about 0.1 to 5.0 micrometres.

2. The sheet material of claim 1, wherein the microporous membrane has a thickness of 1-1000 micrometres.

3. (canceled)

4. The sheet material of claim 1, wherein the microporous membrane comprises a material selected from: poly(ether sulfone), poly(sulfone), poly(vinyldifluoride), poly(vinyl chloride), cellulose, chemically modified cellulose (such as nitrocellulose or cellulose ester), poly(carbonate), poly(tetrafluoroethylene), poly(propylene), poly(ethylene), poly(ethylene terephthalate), poly(urethane), acrylic copolymer, nylon and combinations thereof.

5. (canceled)

6. The sheet material of claim 1, wherein the microporous membrane has an open volume of about 10-90%.

7. The sheet material of claim 1, wherein the microporous membrane is associated with a material impermeable to the solution comprising a colour former.

8. The sheet material of claim 7, wherein the material impermeable to the solution comprising a colour former is a second sheet material having a thickness of about 5-250 micrometres.

9. The sheet material of claim 7, wherein the material impermeable to the solution comprising a colour former comprises a material selected from: poly(ethylene terephthalate), poly(urethane), poly(propylene), poly(ethylene), poly(carbonate), poly(styrene) and combinations thereof.

10. (canceled)

11. The sheet material of claim 1, wherein the colour former is a phthalide-based, fluoran-based, sulfophthalide-based or sulfofluoran-based leuco dye.

12. The sheet material of claim 11, wherein the colour former is chosen from: 2-Phenylamino-3-methyl-6-diethylaminofluorane, 3-di-n-Butylamino-6-methyl-7-phenylaminofluorane, 2-(2′, 4′-dimethylphenylamino-3-methyl-6-diethylaminofluorane), 3,3-bis(p-(dimethylamino)phenyl)-6-(dimethylamino)phthalide, 3-Diethylaminobenzofluorane, Ethyl 6′-(diethylamino)-3-oxospiro[2-benzofuran-1,9′-xanthene]-2′-carboxylate, 7-[4-(Diethylamino)-2-ethoxyphenyl]-7-(2-methyl-1-octyl-1H-indol-3-yl)furo[3,4-b]pyridin-5(7H)-one, 2-Di(phenylmethyl)amine-6′-diethylaminospiro(isobenzofuran-1(3H), 9′-[9H] xanthen-3-one, 3-(N-ethyl-N-isopentylamino)-6-methyl-7-anilinofluorane, 6′-(Diethylamino)-1′,2′-benzofluoran, 7-(4-(Diethylamino)-2-ethoxyphenyl)-7-(1-ethyl-2-methyl-1H-indol-3-yl) furo[3,4-b]pyridin-5(7H)-one and combinations thereof.

13. The sheet material of claim 1, wherein the solution comprising a colour former is an organic liquid.

14. (canceled)

15. The sheet material of claim 1, wherein the colour former constitutes 1-80% of the total weight of the solution comprising a colour former.

16. The sheet material of claim 1, wherein the solution comprising a colour former further comprises a thickening agent.

17. The sheet material of claim 1, wherein the solution comprising a colour former has a viscosity of 1.0×10⁻⁴ to 1×10⁷ Pascal seconds.

18-19. (canceled)

20. The sheet material of claim 16, wherein the thickening agent is present in the solution comprising a colour former at 1-50% of the total weight.

21. The sheet material of claim 1, wherein 10-100% of the open volume of the microporous membrane is occupied by the solution comprising a colour former.

22. A pressure imaging means comprising two sheet materials, wherein a first sheet material is the sheet material of claim 1, and a second sheet material comprises a colour developer.

23. (canceled)

24. The pressure imaging means of claim 22, wherein the second sheet material further comprises a binder for the colour developer.

25. (canceled)

26. A process for the impregnation of a microporous membrane with a solution comprising a colour former, comprising:
diluting the colour former solution in a volatile solvent,
impregnating the microporous membrane with the resulting solution and
removing the volatile solvent,
wherein the microporous membrane has a pore size of about 0.1 to 5.0 micrometres.

27. The process of claim 26, wherein the volatile solvent is an organic solvent.

28. (canceled)

29. The process of claim 26, wherein the colour former solution is diluted in the volatile solvent at a concentration of 1-90% of the total weight.
